(19) United States
(12) Patent Application Publication
(10) Pub. No.: US 2003/0036453 A1
(43) Pub. Date: Feb. 20, 2003

(54) Planet gear retarder for a servo motor

(76) Inventor: Kun-Sheng Kuo, Hsien-Hsi Hsiang (TW)

Correspondence Address: Hedman & Costigan, P.C., 1185 Avenue of the Americas, New York, NY, 10036-2646, US

(21) Appl. No.: 09/933,103

(22) Filed: Aug. 20, 2001

(51) Int. Cl. F16H 37/02; F16H 57/08

(52) U.S. Cl. 475/210; 475/346

(57) ABSTRACT

A planet gear retarder for a servo motor has a spindle extending through two semi-housings. The spindle has a central gear secured at a middle portion thereof. Two first planet gears and two second planet gears are coaxially assembled in the semi-housings and at diametrically opposite sides of the spindle. The first planet gears are engaged with the central gear. A belt gear is provided at an outer periphery of the second semi-housing and connected with the major power source by a first belt. An input axle has a gear end formed at a first end thereof, and a second end extending outside the second semi-housing. The second planet gears are engaged with the gear end. A driven wheel is secured on the second end of the input axle and connected with a servo motor by a second belt.

### BACKGROUND OF THE INVENTION

1. Field of the Invention

The present invention is related to a planet gear retarder for a servo motor.

2. Description of Related Art

A servo motor connected with a retarder is used to change its output rotation speed. In general, the retarder is a planet gear type as shown in FIG. 4. The servo motor (60) has an output axle (61) connected with a first axle (71) in the planet gear retarder (70). The power of the first axle (71) is transmitted to the output axle (75) by a planet gear assembly (73) engaged with the first axle (71). The output axle (75) extends out of a housing of the retarder and has an output gear (76) assembled thereon. Via the output gear (76), the power is transmitted to other mechanisms. However, the servo motor (60) and the retarder (70) are configured in a line, whereby the overall size of the servo motor is very large.

FIG. 3 shows an example of the servo motor (60) and the retarder (70) used in a braiding machine. The servo motor (60) enables the output rotation speed and rotation direction of the retarder (70) to be changed. However, as mentioned above, the overall horizontal size of the servo motor (60) and the retarder (70) is large, so that it is very inconvenient to use and transport the machine.

Therefore, the invention provides an improved planet gear retarder for a servo motor to mitigate and/or obviate the aforementioned problems.

### SUMMARY OF THE INVENTION

The main objective of the present invention is to provide a planet gear retarder for a servo motor which has a small axial size.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a planet gear retarder in accordance with the invention assembled with a servo motor;

FIG. 2 is a cross sectional view of the planet gear retarder in FIG. 1;

FIG. 3 is a perspective view of a conventional planet gear retarder; and

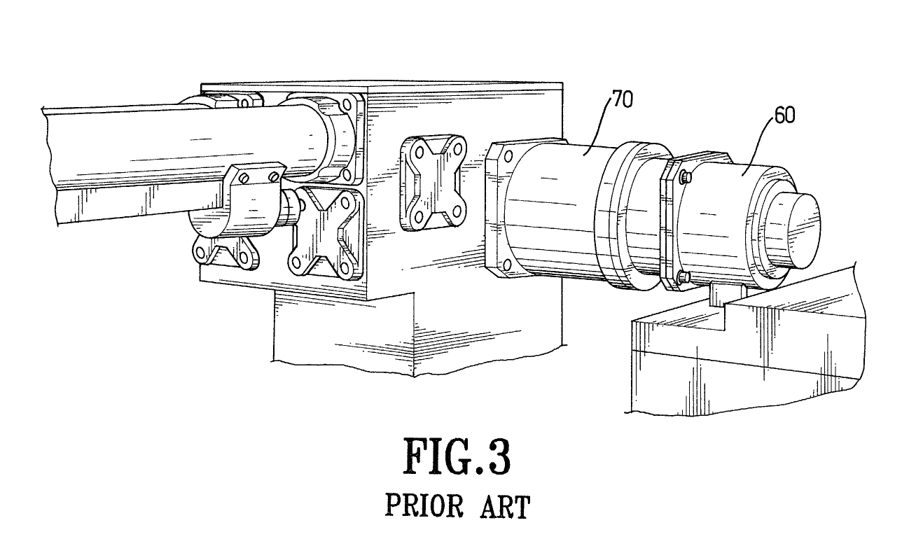

FIG. 4 is a cross sectional view of the conventional planet gear retarder in FIG. 3.

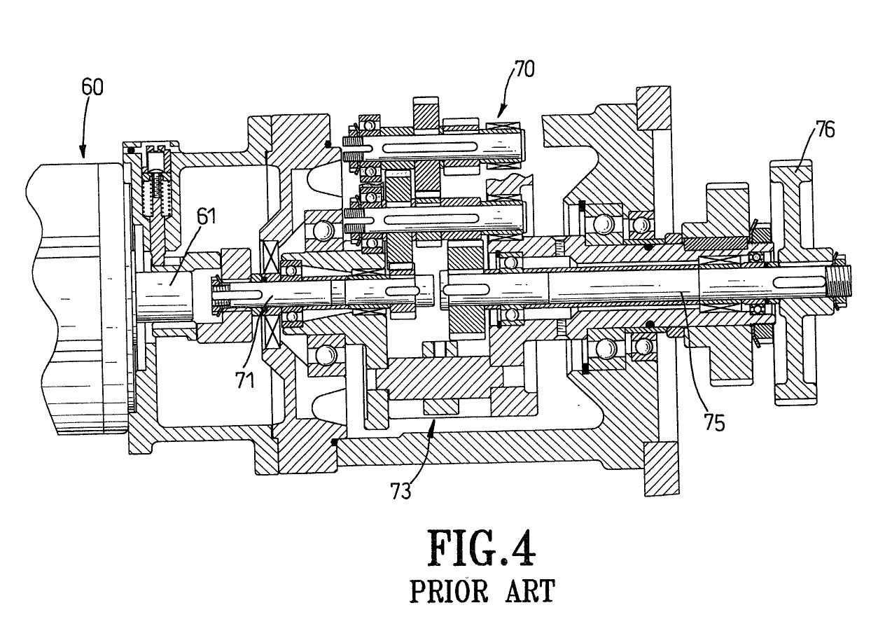

### DETAILED DESCRIPTION OF THE PREFERRED EMBODIMENT

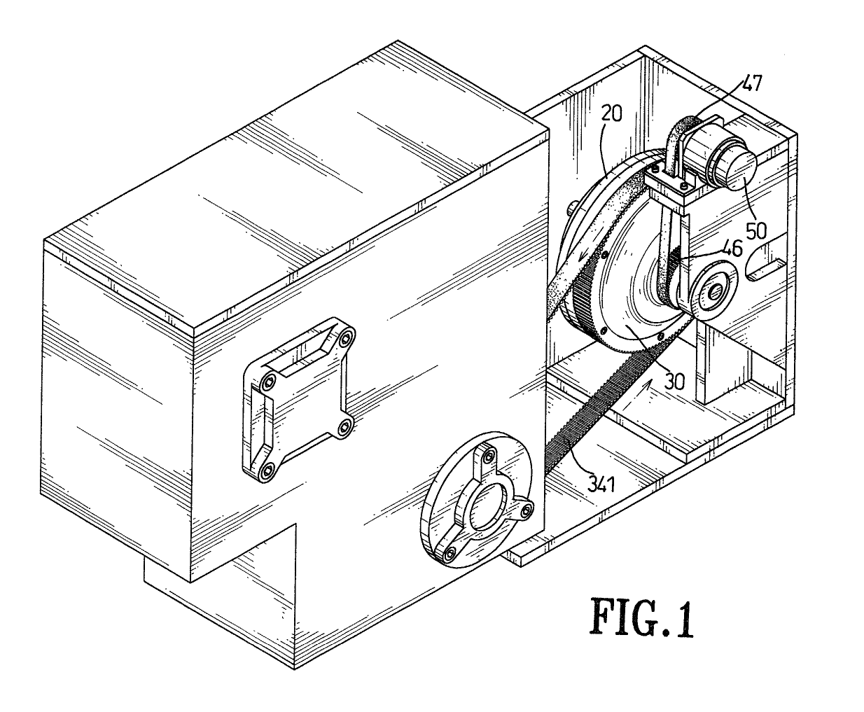

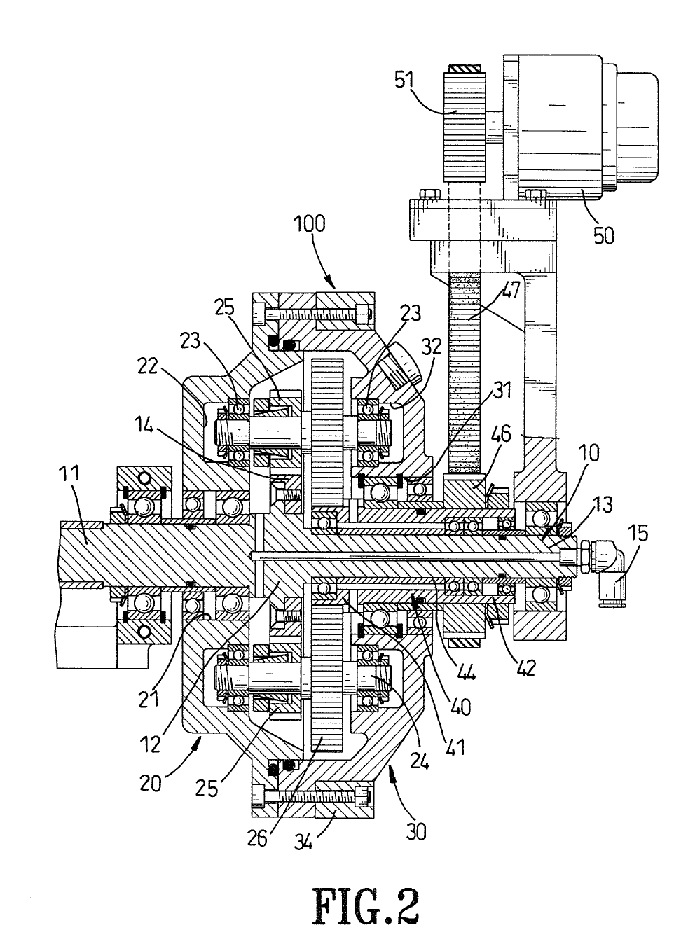

Referring to FIGS. 1 and 2, a planet gear retarder (100) in accordance with the invention is cooperated with a servo motor (50) for operation of the servo motor (50). The retarder (100) has a spindle (10) extending through a first semi-housing (20) and a second semi-housing (30) detachably mounted together. The spindle (10) has a first segment (11) to output power, and a second segment (13) mounted on a frame (not numbered).

A step (12) is formed at a middle portion of the spindle (10) between the first segment (11) and the second segment (13). A central gear (14) is secured on the step (12). A ventilative pipe (15) is axially inserted in the spindle (10) via the second segment (13).

The first semi-housing (20) is shaped as a disk and has a first opening (21) for the first segment (11) of the spindle (10) extending therethrough. At least two first recesses (22) are defined at diametrically opposite sides of the first opening (21) and each have a first bearing (23) assembled therein. The second semi-housing (30) is also shaped as a disk and substantially symmetrical to the first semi-housing (20). A second opening (31) is defined therein for the second segment (13) of the spindle (10) extending therethrough. At least two second recesses (32) are defined at diametrically opposite sides of the second opening (31) and each also have a first bearing (23) assembled therein. Two shafts (24) are respectively assembled in the first bearings (23) in alignment with each other in the first and second semi-housings (20, 30). Two first planet gears (25) are respectively secured on the shafts (24) and engaged with the central gear (14). Two second planet gears (26) are respectively integrated with the shafts (24) and coaxial to the first planet gears (25).

A belt gear (34) is assembled at an outer periphery of the second semi-housing (30) and connected with a power source by a first belt (341), as shown in FIG. 1.

A hollow input axle (40) extends in the second semi-housing (30) via the second opening (31). The input axle (40) has a gear end (41) formed at a first end thereof and engaged with the second planet gears (26), and has a second end (42) outside the second semi-housing (30). Bearings (not numbered) are respectively provided between the gear end (41) and the spindle (10), and between the second end (42) and the spindle (10). A sleeve (44) is provided on the spindle (10) and between the bearings at the gear end (41) and the second end (42). Thus, the input axle (40) is radially spaced apart from the spindle (10), and they will not interfere with each other and are able to rotate freely.

A driven wheel (46) is secured on the second end (42) of the input axle (40) and connected with a driving wheel (51) on the servo motor (50) by a second belt (47). The servo motor (50) is mounted above the retarder (100).

When the servo motor is not actuated, the input axle (40) is stationary, and the first semi-housing (20) and the second semi-housing (30) is driven by the power source via the first belt (341) and the belt gear (34) to rotate. Thus, the first planet gear (25) and the second planet gear (26) are respectively revolved round the central gear (14) and the gear end (41). As the gear end (41) is not turned, the second planet gears (26), as well as the shafts (24) integrated with them, will be rotated. Then, the first planet gears (25) also have the same rotation as the second planet gears (26). The central gear (14) engaged with the first planet gears (25), as well as the spindle (10), is driven by the first planet gears (25) to rotate and the power is output via the first segment (11).

When the servo motor is actuated, the input axle (40) is driven to rotate via the driving wheel (51), the belt (47) and the driven wheel (46), and the gear end (41) has a rotation. Because the revolution speed is a constant, the rotation speed of the second planet gears (26) will be changed to correspond to the rotation of the gear end (41). Whereby, the rotation speeds of the first planet gears (25) and the central gear (14) are also changed. Then, the output rotation speed of the first segment ( 1) is changed.

According to the present invention, the retarder (100) has a very small axial size because the housings (20, 30) are designed as disks. Furthermore, the servo motor (50) is provided above the retarder (100), and so when the present retarder (100) is compared with the conventional retarder, the overall horizontal size of the retarder (100) and the servo motor (50) is reduced greatly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A planet gear retarder (100) for a servo motor, comprising:
a spindle (10) having a first segment (11), a second segment (13), and a central gear (14) secured on a middle portion thereof between the first segment (11) and the second segment (13);
a housing having a first opening (21) for the first segment (11) of the spindle (10) extending thereout, a second opening (31) for the second segment (13) of the spindle (20) extending thereout, at least two shafts (24) rotatably provided at diametrically opposite sides of the spindle (10), the shafts (24) each having a first planet gear (25) engaged with the central gear (14) and a second planet gear (26) coaxially secured on thereon, and a belt gear (34) drivingly secured on an outer periphery of the housing and connected with a power source by a first belt (341); and
a hollow input axle (40) provided on the second segment (13) and inserted in the housing via the second opening (31) and radially spaced apart from the spindle (10), the input axle (40) having a gear end ( 1l) formed at a first end thereof and engaged with the second planet gear (26), a second end (42) extending outside the second opening (31), and a driven wheel (46) secured on the second end (42) and connected with a driving wheel (51) of a servo motor (50) by a second belt (47).

2. The planet gear retarder as claimed in claim 1, wherein the spindle (10) has a step (12) formed at the middle portion thereof, and the central gear (14) is secured on the step (12).

3. The planet gear retarder (100) as claimed in claim 1, wherein the housing is composed of a first semi-housing (20) and a second semi-housing (30) detachably mounted together.

4. The planet gear retarder (100) as claimed in claim 3, wherein the first semi-housing (20) has two first recesses (22) defined at diametrically opposite sides of the first opening (21), and two bearings (23) respectively mounted in the first recesses (22) to receive first ends of the shafts (24) therein; the second semi-housing (30) has two second recesses (32) defined at diametrically opposite sides of the second opening (31), and two bearings (23) respectively mounted in the second recesses (32) to receive second ends of the shafts (24) therein.

5. The planet gear retarder as claimed in claim 3, wherein the belt gear (34) is drivingly secured to an outside periphery of the second semi-housing (30).

6. The planet gear retarder as claimed in claim 1, wherein the input axle (40) has bearings provided between the gear end (41) thereof and the spindle (10) and between the second end (42) thereof and the spindle (10), and a sleeve (44) provided on the spindle (10) and between the bearings at the gear end (41) and the second end (42).

7. The planet gear retarder as claimed in claim 1, wherein the spindle (10) has a ventilative pipe (15) axially inserted therein via the second segment (13) thereof.
